(19) United States
(12) Patent Application Publication
(10) Pub. No.: US 2005/0084286 A1
(43) Pub. Date: Apr. 21, 2005

(54) Image forming unit and image forming apparatus

(75) Inventors: Kazuaki Iikura, Kashiwazaki-shi (JP); Masaya Okamoto, Kashiwazaki-shi (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 10/899,141

(22) Filed: Jul. 27, 2004

(30) Foreign Application Priority Data
Oct. 16, 2003 (JP) 2003-356176

(51) Int. Cl. G03G 21/18

(52) U.S. Cl. 399/111; 399/113

(57) ABSTRACT

An image forming unit includes: an image carrier that carries a toner image; an intermediate transfer member being in contact with the image carrier in an area, onto which the toner image on the image carrier is transferred; and an image carrier cleaner that cleans residual toner on the image carrier, being disposed in contact with the image carrier at a point different from the area where the intermediate transfer member is in contact therewith. Each of the image carrier, intermediate transfer member and image carrier cleaner is detachably attachable to the image forming apparatus main body.

### BACKGROUND OF THE INVENTION

1. Field of the Invention

The present invention relates to an image forming apparatus such as a printer, copier, and facsimile and an image forming unit used therefor.

2. Description of a Related Art

As an image forming apparatus, an apparatus for forming a color image by the rotation of a rotary developing device having developing units of four colors of yellow, magenta, cyan, and black is known.

In this type of the image forming apparatus, it is publicly known that an image forming unit is formed by unitizing a photoconductor, an intermediate transfer belt, and a photoconductor cleaner for cleaning residual toner on the photoconductor, and this image forming unit is attached to and detached from the image forming apparatus main body (see Publications of Japanese Patent No. 3295416, and Japanese Patent Application Nos. 2000-227688 and 2001-83766).

However, in the above described conventional example, the image forming unit becomes upsized, and, when the image forming unit is attached to and detached from the image forming apparatus main body, large working space is required. There has been a problem that the image forming apparatus becomes upsized in order to ensure the large working space.

### SUMMARY OF THE INVENTION

The present invention provides an image forming unit having an image carrier, an intermediate transfer member, and an image carrier cleaner that can easily be attached to and detached from an image forming apparatus main body without upsizing an image forming apparatus. The present invention also downsizes an image forming apparatus having an image carrier, an intermediate transfer member, and an image carrier cleaner that can easily be attached to and detached from an image forming apparatus main body.

According to an aspect of the present invention, an image forming unit has an image carrier that carries a toner image, an intermediate transfer member being in contact with the image carrier in an area, onto which the toner image on the image carrier is transferred, and an image carrier cleaner that cleans residual toner on the image carrier, being disposed in contact with the image carrier at a point different from the area where the intermediate transfer member is in contact therewith. Each of the image carrier, intermediate transfer member and image carrier cleaner is detachably attachable to the image forming apparatus main body.

### BRIEF DESCRIPTION OF THE DRAWINGS

An embodiment of the present invention will be described in detail based on the following figures, wherein:

FIG. 1 is a side view of an image forming apparatus according to an embodiment of the invention;

FIG. 2 is a side view showing a state in which an image forming unit is detached from an image forming apparatus main body;

FIG. 3 schematically shows a direction in which the image forming unit is attached to and detached from the image forming apparatus main body;

FIG. 4 schematically shows a direction and a state in which the image forming unit is attached to and detached from the image forming apparatus main body; and

FIG. 5 is an enlarged view showing a direction in which an image carrier of the image forming unit approaches and separates from the rotary developing device.

### DETAILED DESCRIPTION OF THE INVENTION

Next, a first embodiment of the invention will be described according to the drawings.

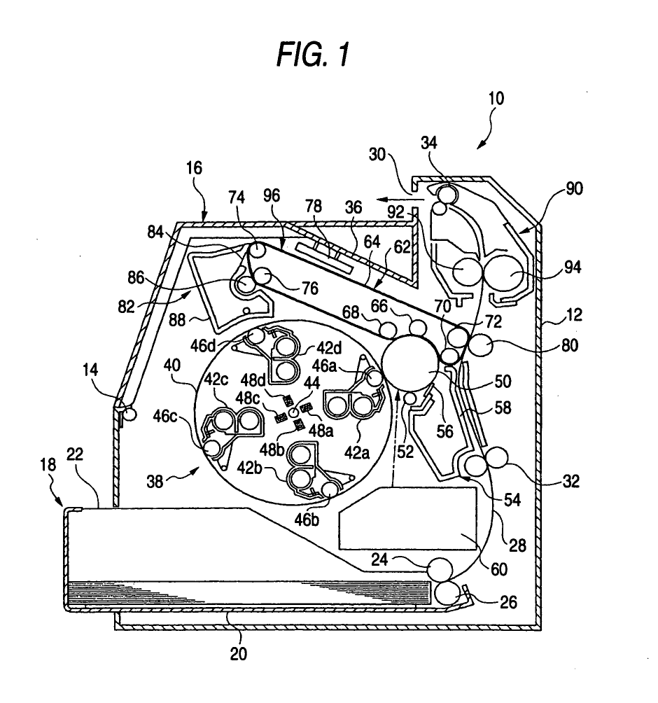

In FIG. 1, the scheme of an image forming apparatus 10 according to the first embodiment of the invention is shown. The image forming apparatus 10 of the first embodiment has an image forming apparatus main body 12, an openable cover 16 rotatable with a rotation supporting point 14 as a center thereof is provided on the upper side of the image forming apparatus main body 12, and a paper feed unit 18, for example, of single stage is disposed at the bottom of the image forming apparatus main body 12.

The paper feed unit 18 has a paper feed unit main body 20 and a paper feed cassette 22 in which paper is accommodated. Near the top of the back end of the paper feed cassette 22, a feed roll 24 for feeding paper from the paper feed cassette 22 and a retard roll 26 for separating fed paper one by one are disposed.

A carrying path 28 is a paper path from the feed roll 24 to a discharge opening 30, and the carrying path 28 is located near the rear side of the image forming apparatus main body 12 (the right side face in FIG. 1) and formed substantially vertically from the paper feed unit 18 to a fixing unit 90, which will be described later. On the upstream side of the fixing unit 90 along the carrying path 28, a secondary transfer roll 80 and a secondary transfer backup roll 72, which will be described later, are disposed, and a registration roll 32 is disposed on the upstream side of the secondary transfer roll 80 and the secondary transfer backup roll 72. Additionally, near the discharge opening 30 of the carrying path 28, a discharging roll 34 is disposed.

Therefore, the paper fed from paper feed cassette 22 of the paper feed unit 18 by the feed roll 24 is separated by the retard roll 26, and only the uppermost paper is guided to the carrying path 28, and temporarily stopped by the registration roll 32. Then, with provided timing, the paper is passed between the secondary transfer roll 80 and the secondary transfer backup roll 72, which will be described later, and the toner image is transferred onto the paper, the transferred toner image is fixed by the fixing unit 90, and the paper is discharged from the discharge opening 30 to a discharging part 36 provided on the upper side of the openable cover 16 by the discharging roll 34. This discharging part 36 is inclined so as to be low at the part of the discharge opening and gradually higher toward the front direction (in the leftward direction in FIG. 1).

In the image forming apparatus main body 12, a rotary developing device 38 is disposed, for example, substantially at the center thereof. The rotary developing device 38 has developing units 42a to 42d for forming toner images of four colors of yellow, magenta, cyan, and black, respectively, within a developing device main body 40 and rotates in the left-handed direction (counter-clockwise in FIG. 1) with a rotary developing device center 44 as the center thereof. The developing units 42a to 42d have developing rolls 46a to 46d, and are pressed in the normal direction of the developing device main body 40 by the elastic bodies 48a to 48d such as coil springs, for example, respectively.

An image carrier 50 including a photoconductor, for example, is disposed so as to abut the rotary developing device 38, and each of the developing rolls 46a to 46d has a circumference a part of which projects from the circumference of the developing device main body 40 by 2 mm, for example, toward the radial direction in the state without abutting the image carrier 50. Further, on both ends of the developing rolls 46a to 46d, tracking rolls (not shown) having slightly larger diameters than those of the developing rolls 46a to 46d are provided so as to rotate coaxially with the developing rolls 46a to 46d, respectively. That is, the developing rolls 46a to 46d of the developing units 42a to 42d are disposed on the periphery of the developing device main body 40 at 90° intervals, respectively, with the rotary developing device center 44 as the center thereof, and, while the tracking rolls of the developing rolls 46a to 46d abut flanges (not shown) provided on both sides of the image carrier 50 and form a predetermined clearance between the developing rolls 46a to 46d and the image carrier 50, the latent image on the image carrier 50 is developed with the toner of the respective colors.

A charging device 52 that includes a charging roll, for example, for uniformly charging the image carrier 50 is provided below the image carrier 50. Additionally, an image carrier cleaner 54 abuts the image carrier 50 on the upstream side of the charging device 52 in the rotating direction of the image carrier 50. The image carrier cleaner 54 includes, for example, a cleaning blade 56 for scraping the residual toner on the image carrier 50 after the primary transfer, and a toner collection bottle 58 for collecting the toner scraped by the cleaning blade 56.

Note that, a rib, for example, is formed on the rear side of the toner collection bottle 58 (the right side in FIG. 1), and the rear side is curved for carrying paper smoothly and forms a part of the carrying path 28.

Below the rotary developing device 38, an exposure device 60 for writing a latent image onto the image carrier 50 that has been charged by the charging device 52 with a beam such as a laser beam is disposed. Additionally, above the rotary developing device 38, an intermediate transfer device 62 for primary-transferring the toner image that has been visualized by the rotary developing device 38 in the first transfer position and carrying it to the second transfer position, which will be described later, is provided.

The intermediate transfer device 62 includes, for example, an intermediate transfer member 64 such as an intermediate transfer belt, a primary transfer roll 66, a wrap-in roll 68, a wrap-out roll 70, the secondary transfer backup roll 72, a scraper backup roll 74, and a brush backup roll 76. The intermediate transfer member 64 has elasticity, for example, and tensed substantially in a flat form so as to have long sides and short sides above the rotary developing device 38. The long side on the upper surface side of the intermediate transfer member 64 is tensed so as to be substantially in parallel to the discharging part 36 provided on the upper side of the image forming apparatus main body 12. Further, the intermediate transfer member 64 has a first transfer part (image carrier wrapping area) that abuts the image carrier 50 in a wrapped manner between the wrap-in roll 68 disposed below the long side of the intermediate transfer member 64 on the upstream side of the primary transfer roll 66 and the wrap-out roll 70 disposed on the downstream side of the primary transfer roll 66, and is wrapped around the image carrier 50 by a predetermined range and turns dependently on the rotation of the image carrier 50. Thus, the intermediate transfer member 64 is primary-transferred with the toner images on the image carrier 50 by superposing them in the order of, for example, yellow, magenta, cyan, and black, and carries the primary-transferred toner image toward the secondary transfer roll 80, which will be described later.

Note that the wrap-in roll 68 and the wrap-out roll 70 are separated from the image carrier 50.

Furthermore, on the rear side of the intermediate transfer member 64 (the right side surface in FIG. 1), a planer part (short side) is formed by the wrap-out roll 70 and the secondary transfer backup roll 72, and the planer part forms the secondary transfer part to face the carrying path 28.

Note that, in the secondary transfer part, the wrap-out roll 70 is located so as to make an angle of 12°, for example, between the intermediate transfer member 64 and the carrying path 28.

The scraper backup roll 74 helps a scraper 84, which will be described later, to scrape the residual toner on the intermediate transfer member 64 after the secondary transfer, and the brush backup roll 76 helps a brush roll 86, which will be described later, to scrape the residual toner on the intermediate transfer member 64 after the secondary transfer.

Above the long side of the intermediate transfer member 64, a sensor 78 such as a reflective photo-sensor, for example, is provided by fixing it on the rear side (inner side) of the openable cover 14. The sensor 78 reads a patch of toner formed on the intermediate transfer member 64, detects the position in the turning direction of the intermediate transfer member 64, and performs toner density detection.

To the secondary transfer backup roll 72 of the intermediate transfer device 62, the secondary transfer roll 80 is opposed with the carrying path 28 therebetween. That is, the position between the secondary transfer roll 80 and the secondary transfer backup roll 72 forms the secondary transfer position, and the secondary transfer roll 80 secondary-transfers the toner image that has been primary-transferred onto the intermediate transfer member 64 onto the paper in the secondary transfer position with the aid of the secondary transfer backup roll 72. Here, the secondary transfer roll 80 is designed so as to separate from the intermediate transfer member 64 when the intermediate transfer member 64 rotates three times, that is, hold the toner images of three colors of yellow, magenta, and cyan, and abut the intermediate transfer member 64 after the toner image of black is transferred thereon. Note that a predetermined potential difference is produced between the secondary transfer roll 80 and the secondary transfer backup roll 72. For example, when the secondary transfer roll 80 is applied with a high voltage, the secondary transfer backup roll 72 is connected to the ground (GND).

An intermediate transfer member cleaner 82 is provided to abut the end of the intermediate transfer member 64 opposite to the image carrier. The intermediate transfer member cleaner 82 includes, for example, the scraper 84 for cleaning by scraping the residual toner on the intermediate transfer member 64 after the secondary transfer, the brush roll 86 for further scraping the toner remaining after the cleaning by the scraper 84, the toner collection bottle 88 for collecting the scraped toner by the scraper 84 and the brush roll 86. The scraper 84 includes a stainless thin plate, for example, and applied with a voltage having a reverse polarity to the toner. The brush roll 86 includes a brush of conductive treated acryl etc., for example. Additionally, while the intermediate transfer member 64 carries the toner images, the scraper 84 and the brush roll 86 are separated from the intermediate transfer member 64, and, with predetermined timing, these abut integrally against the intermediate transfer member 64.

Above the secondary transfer position, the fixing unit 90 is disposed. The fixing unit 90 has a heating roll 92 and a pressure roll 94, fixes the toner image that has been secondary-transferred onto the paper by the secondary transfer roll 80 and the secondary transfer backup roll 72 on the paper, and carries the paper toward the discharging roll 34.

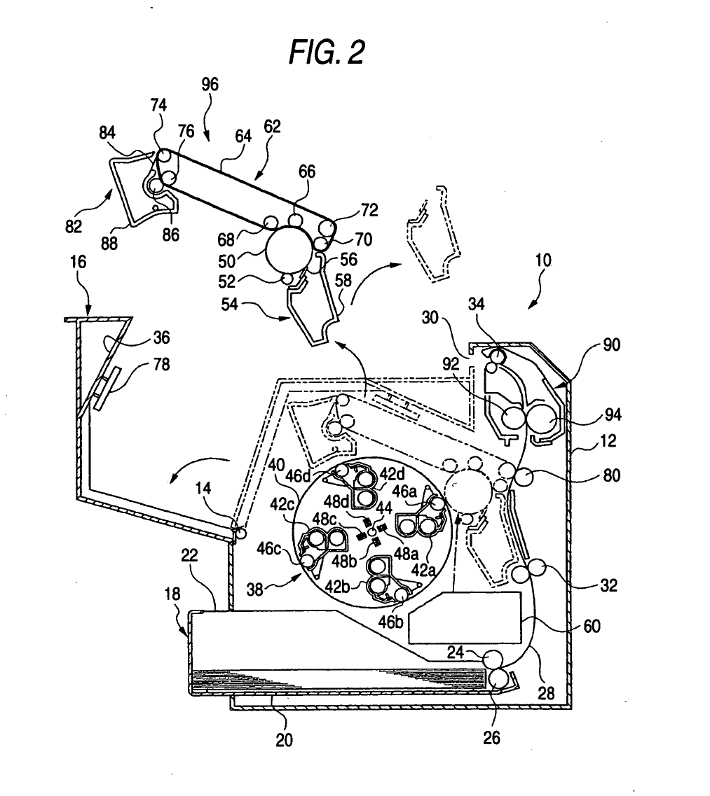

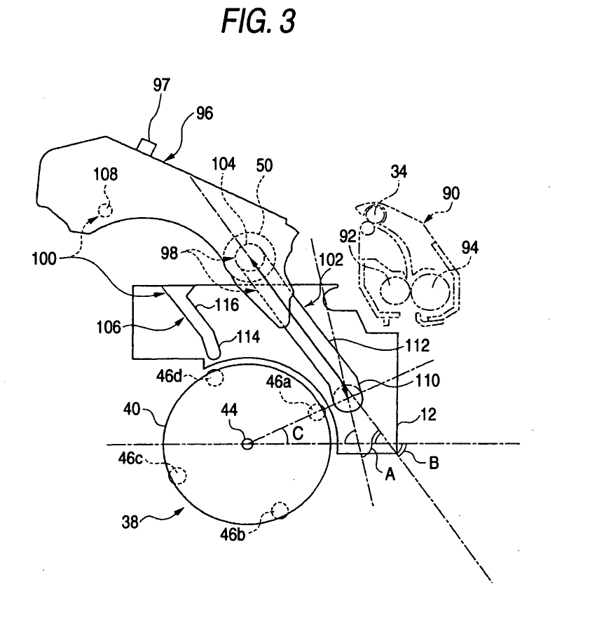

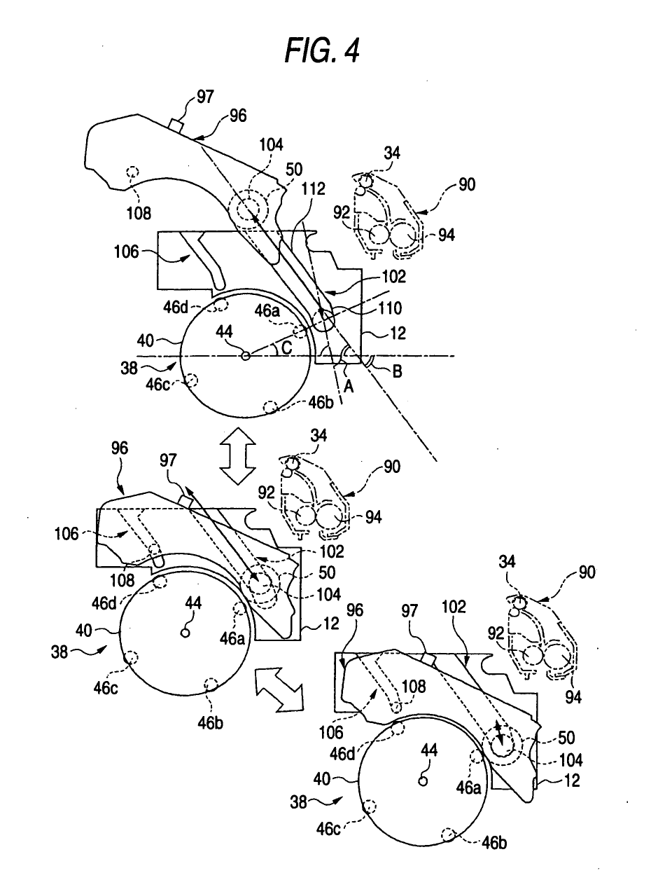

The image forming unit 96 has a holding portion 97 (which is described later using FIGS. 3 and 4) provided on the upper side thereon, and is formed by integrating the intermediate transfer device 62, the image carrier 50, the charging device 52, the image carrier cleaner 54, and the intermediate transfer member cleaner 82. That is, in the image forming unit 96, the intermediate transfer device 62 having the intermediate transfer member 64 extends toward the front side of the image carrier 50 (the left side in FIG. 2), and the image carrier cleaner 54 is disposed below the rear side of the image carrier 50 (below the right side in FIG. 2). Further, the image forming unit 96 has the intermediate transfer member cleaner 82 disposed at the end of the intermediate transfer device 62 opposite to the image carrier. Thus, in the image forming unit 96, the direction in which the intermediate transfer member 64 extends and the direction in which the image carrier cleaner 54 is disposed are bent so as to form an angle of more than 90° and less than 180° with the secondary transfer position as an apex to surround the rotary developing device 38. The image forming unit 96 is disposed immediately below the discharging part 36 of the openable cover 16, detachably provided to the image forming apparatus main body 12 and attached or detached by opening the openable cover 16.

Further, the image carrier 50, the image carrier cleaner 54, the intermediate transfer member 64, and intermediate transfer member cleaner 82 can be attached to and detached from the image forming unit 96.

Next, the operation of the above described first embodiment will be described.

When an image forming signal is transmitted, the image carrier 50 is uniformly charged by the charging device 52, and a beam is output to the charged image carrier 50 from the exposure device 60 based on the image signal. The surface of the image carrier 50 is exposed to the beam from the exposure device 60 and a latent image is formed thereon. The latent image on the image carrier 50 formed by the exposure device 60 has toner images of yellow, magenta, cyan, and black developed by the rotary developing device 38 and transferred onto the intermediate transfer member 64 by being superposed. The waste toner remaining on the image carrier 50 in the primary transfer is scraped by the image carrier cleaner 54 and collected.

On the other hand, in response to a paper feed signal etc., the paper accommodated in the paper feed cassette 22 is fed by the feed roll 24, separated by the retard roll 26 to be guided to the carrying path 28, temporarily stopped by the registration roll 32, and guided between the secondary transfer roll 80 and the secondary transfer backup roll 72 with provided timing. When the paper is guided between the secondary transfer roll 80 and the secondary transfer backup roll 72, the toner image that has been primary-transferred onto the intermediate transfer member 64 is secondary-transferred onto the paper by the secondary transfer roll 80 and the secondary transfer backup roll 72. After the secondary transfer, the waste toner remaining on the intermediate transfer member 64 is scraped by the intermediate transfer member cleaner 82 and collected.

The paper onto which the toner image has been transferred is guided to the fixing unit 90, and the toner image is fixed by the thermal pressure by the heating roll 92 and the pressure roll 94. The paper onto which the toner image has been fixed is discharged from the discharge opening 30 to the discharging part 36 by the discharging roll 34.

Next, an attaching and detaching method of the image forming unit 96 of the first embodiment will be described.

In FIG. 2, a state in which the image forming unit 96 of the first embodiment is detached from the image forming apparatus main body 12 is shown. When the image forming unit 96 is detached from the image forming apparatus 10, the image forming apparatus 10 has the top part of the image forming apparatus main body 12 opened by rotating the openable cover 16 of the image forming apparatus main body 12 with the rotation supporting point 14 as the center thereof. The image forming unit 96 is disposed so that the intermediate transfer device 62 and the image carrier 50 may be located between the fixing unit 90 and the rotary developing device 38, and detached from the image forming apparatus main body 12 in a diagonally front direction (in the diagonally upper left direction in FIG. 2) through the space between the fixing unit 90 and the rotary developing device 38. Thus, the image forming unit 96 is detached without opening the carrying path 28.

Further, in the state in which the image forming unit 96 is detached from the image forming apparatus main body 12, the image carrier 50 and the image carrier cleaner 54 and the intermediate transfer device 62 and the intermediate transfer member cleaner 82 are detachable, respectively, and thereby, the respective members can be replaced easily according to their lives.

When the image forming unit 96 is attached to the image forming apparatus main body 12, the attachment is performed by the procedure reverse to the procedure when the image forming unit 96 is detached from the image forming apparatus 10.

In FIGS. 3 and 4, the direction in which the image forming unit 96 is attached to and detached from the image forming apparatus main body 12 is schematically shown. The holding portion 97 is held and the unit is guided by a main guide part 98 and auxiliary guide part 100 so that the image forming unit 96 is attached to or detached from the image forming apparatus main body 12 in a predetermined direction. The holding portion 97 is formed, for example, from a resin or the like having flexibility and provided on top of the image forming unit 96 so as to make the unit in an insertion attitude (the attitude shown in FIG. 3) into the image forming apparatus main body 12 when holding the holding portion 97 from above, for example. That is, the image forming unit 96 is designed so as to be held inclined with the image carrier cleaner 54 located below when the image forming unit 96 is lifted upwards by holding the holding portion 97. The main guide part 98 includes, for example, a guide groove 102 provided on the image forming apparatus main body 12 side and a protruding portion 104 provided in the image forming unit 96. The protruding portion 104 is arranged so as to be formed in a cylindrical shape coaxial with the image carrier 50 for engaging with the guide groove 102 and move along the guide groove 102. The auxiliary guide part 100 includes an auxiliary groove 106 provided on the image forming apparatus main body 12 side and a protruding portion 108 provided in the image forming unit 96. The protruding portion 108 is arranged so as to be formed in a cylindrical shape for engaging the auxiliary groove 106 and move along the auxiliary groove 106. Further, the upper end of the auxiliary groove 106 is opened widely so as to engage with the protruding portion 108 easily.

The guide groove 102 has an approach and separation guide groove 110 formed at an angle A relative to the horizontal line on the lower side thereof and a movement guide groove 112 formed at an angle B relative to the horizontal line on the upper side thereof. Further, the auxiliary groove 106 has an approach and separation auxiliary guide groove 114 formed at an angle A relative to the horizontal line on the lower side thereof and a movement auxiliary guide groove 116 formed at an angle B relative to the horizontal line on the upper side thereof. The angle A is 70°, for example, and the angle B is 55°, for example. Accordingly, when the protruding portion 104 and the protruding portion 108 are moved along the approach and separation guide groove 110 and the approach and separation auxiliary guide groove 114, the image forming unit 96 moves in directions approaching and separating from the substantially tangential direction of the rotary developing device 38. Further, when the protruding portion 104 and the protruding portion 108 are moved along the movement guide groove 112 and the movement auxiliary guide groove 116, the image forming unit 96 moves in the substantially tangential direction passing through the development position of the rotary developing device 38. Thus, the protruding portion 104 and the protruding portion 108 are moved along the guide groove 102 and the guide groove 106, and thereby, the image forming unit 96 is allowed to be attached to or detached from the image forming apparatus main body 12 in the substantially tangential direction passing through the development position of the rotary developing device 38 in the predetermined attitude.

In addition, the lower end of the guide groove 102 is formed to locate the axis (center) of the image carrier 50 and the protruding portion 104 on the normal line of the rotary developing device 38 extending at an angle C from the rotary developing device center 44 relative to the horizontal line and support the image carrier 50 and the protruding portion 104. The angle C is 25°, for example. That is, the protruding portion 104 is supported by the lower end of the guide groove 102 so that the image carrier 50 may be positioned in a predetermined position where development can be performed and may not be displaced by receiving pressure from the rotary developing device 38. Thus, the image forming unit 96 can be easily attached to and detached from the image forming apparatus main body 12 while being prevented from being scratched by contacting the fixing unit 90 etc.

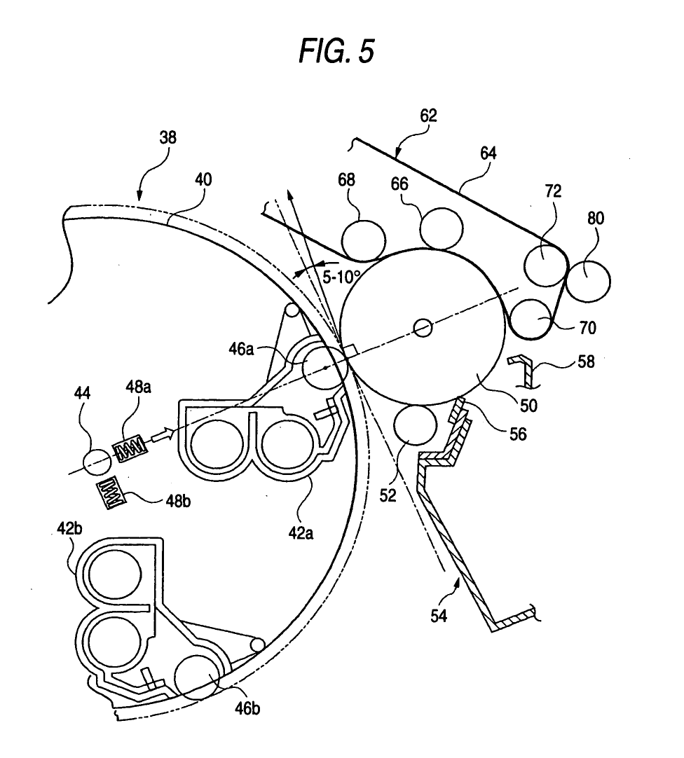

In FIG. 5, details about the direction in which the image carrier 50 of the image forming unit 96 approaches and separates from the rotary developing device 38 are shown. As described above, when the image forming unit 96 is guided by the main guide part 98 and the auxiliary guide part 100, the image carrier 50 is attached or detached in the substantially perpendicular line direction relative to the normal line passing through the development position of the rotary developing device 38 (in the substantially tangential line passing through the development position of the developing device 38). Thus, the direction in which the image forming unit 96 is attached to and detached from the image forming apparatus main body 12 and the image carrier 50 is separated from the rotary developing device 38 is 5° to 10° above relative to the tangential direction passing through the development position of the developing device 38, for example.

Further, in the case where the image carrier 50 abuts one of the developing rollers 46a to 46d in another position other than on the normal line passing through the development position of the rotary developing device 38, the image carrier 50 is attached and detached in a direction substantially perpendicular to the line segment connecting the center of the image carrier 50 and the center of the one of the developing rollers 46a to 46d.

By the way, FIG. 5 shows the direction in which the image carrier 50 of the image forming unit 96 approaches and separates in the condition in which the rotary developing device 38 is in a developable position, however, the image carrier 50 may move in the approaching and separating direction in a condition in which the rotary developing device 38 is separated in the position where the developing rollers 46a to 46d can not abut the image carrier 50.

As described above, according to an aspect of the invention, an image forming unit includes an image carrier that carries a toner image, an intermediate transfer member being in contact with the image carrier in an area, onto which the toner image on the image carrier is transferred, and an image carrier cleaner that cleans residual toner on the image carrier, being disposed in contact with the image carrier at a point different from the area where the intermediate transfer member is in contact therewith. Each of the image carrier, intermediate transfer member and image carrier cleaner is detachably attachable to the image forming apparatus main body. Therefore, the image carrier, the intermediate transfer body, and the image carrier cleaner can easily be attached to and detached from the image forming apparatus main body without upsizing the image forming apparatus.

The image carrier may be provided near an end of the intermediate transfer member.

The lengthwise direction of the intermediate transfer member and the point where the image carrier cleaner is in contact with the image carrier may make an angle of more than 90° and less than 180° with respect to the center of the area where the intermediate transfer member is in contact with the image carrier. Further, the intermediate transfer member and the image carrier cleaner may be disposed along a developing device provided within the image forming apparatus main body. Therefore, the image forming unit can be disposed on the periphery of the developer unit, and the image forming unit can easily be attached to and detached from the image forming apparatus main body, without upsizing the image forming apparatus.

Further, the image carrier cleaner may be located nearest to one of side walls of the image forming apparatus main body when the image forming unit is attached to the image forming apparatus main body. Therefore, even when the image forming unit is attached to or detached from the image forming apparatus main body, contamination of the image carrier and the intermediate transfer body by the toner slipping out from the image carrier cleaner can be prevented.

Furthermore, a holding portion may be further included and the image forming unit is brought into a state of readiness to be attached to the image forming apparatus main body when the holding portion is held. Therefore, the operation when the image forming unit is attached to or detached from the image forming apparatus main body can be made easier.

The intermediate transfer body may have a belt having elasticity. Further, the intermediate transfer member may form a primary transfer portion that is an area where the intermediate transfer member is in close contact with the image carrier to transfer the toner image from the image carrier. Therefore, a degree of flexibility in providing the intermediate transfer body is increased, and thereby, the image forming unit that can be easily attached to and detached from the image forming apparatus main body can be formed easily.

Further, the intermediate transfer member may form a planer portion from which the primary-transferred toner image is secondary-transferred to a recording sheet. Furthermore, the image carrier cleaner may have a toner collection bottle for collecting toner, and the toner collection bottle may form a part of a carrying path for carrying recording sheets. Moreover, the intermediate transfer body may have a surface substantially parallel to a part of an outer shape of the image forming apparatus main body. Therefore, the carrying path having a substantially linear form can be formed, and the image forming unit can be easily attached to and detached from the image forming apparatus main body without upsizing the image forming apparatus.

Further, an intermediate transfer member cleaner for cleaning residual toner on the intermediate transfer member may be included. The intermediate transfer member cleaner may be provided at an end of the intermediate transfer member opposite to the image carrier side. Therefore, cleaners are provided to the image carrier and the intermediate transfer body, respectively, and thereby, waste toner carrying part for carrying waste toner can be made unnecessary, and the risk of slipping out of toner can be reduced.

Another aspect of the invention provides an image forming apparatus including an image forming apparatus main body, and an image forming unit detachably attachable to the image forming apparatus main body. The image forming unit includes an image carrier that carries a toner image, an intermediate transfer member being in contact with the image carrier in an area, onto which the toner image on the image carrier is transferred, and an image carrier cleaner that cleans residual toner on the image carrier, being disposed in contact with the image carrier at a point different from the area where the intermediate transfer member is in contact therewith. Therefore, the image forming apparatus having the image carrier, the intermediate transfer body, and the image carrier cleaner that can easily be attached to and detached from the image forming apparatus main body can be downsized.

Further, another aspect of the invention is an image forming apparatus including an image forming apparatus main body, a developing device provided within the image forming apparatus main body, and an image forming unit detachably attachable to the image forming apparatus main body. The image forming unit includes an image carrier that carries a toner image formed by the developing device, an intermediate transfer member being in contact with the image carrier in an area, onto which the toner image on the image carrier is transferred, and an image carrier cleaner that cleans residual toner on the image carrier, being disposed in contact with the image carrier at a point different from the area where the intermediate transfer member is in contact therewith. Therefore, the image forming apparatus having the image carrier, the intermediate transfer body, and the image carrier cleaner that can easily be attached to and detached from the image forming apparatus main body in which the developer unit is provided can be downsized.

The foregoing description of the embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No. 2003-356176 filed on Oct. 16, 2003 including specification, claims, drawings and abstract is incorporated herein by reference in its entirety.

1. An image forming unit comprising:
an image carrier that carries a toner image;
an intermediate transfer member being in contact with the image carrier in an area, onto which the toner image on the image carrier is transferred; and
an image carrier cleaner that cleans residual toner on the image carrier, being disposed in contact with the image carrier at a point different from the area where the intermediate transfer member is in contact therewith, wherein each of the image carrier, intermediate transfer member and image carrier cleaner is detachably attachable to the image forming apparatus main body.

2. The image forming unit according to claim 1, wherein the image carrier is provided near an end of the intermediate transfer member.

3. The image forming unit according to claim 1, wherein the lengthwise direction of the intermediate transfer member and the point where the image carrier cleaner is in contact with the image carrier make an angle of more than 90° and less than 180° with respect to the center of the area where the intermediate transfer member is in contact with the image carrier.

4. The image forming unit according to claim 1, wherein the intermediate transfer member and the image carrier cleaner are disposed along a developing device provided within the image forming apparatus main body.

5. The image forming unit according to claim 1, wherein the image carrier cleaner is located nearest to one of side walls of the image forming apparatus main body when the image forming unit is attached to the image forming apparatus main body.

6. The image forming unit according to claim 1, further comprising a holding portion, wherein the image forming unit is brought into a state of readiness to be attached to the image forming apparatus main body when the holding portion is held.

7. The image forming unit according to claim 1, wherein the intermediate transfer member comprises a belt having elasticity.

8. The image forming unit according to claim 1, wherein the intermediate transfer member forms a primary transfer portion that is an area where the intermediate transfer member is in close contact with the image carrier to transfer the toner image from the image carrier.

9. The image forming unit according to claim 1, wherein the intermediate transfer member forms a planer portion from which the primary-transferred toner image is secondary-transferred to a recording sheet.

10. The image forming unit according to claim 1, wherein the image carrier cleaner has a toner collection bottle for collecting toner, and the toner collection bottle forms a part of a carrying path for carrying a recording sheet.

11. The image forming unit according to claim 1, wherein the intermediate transfer member has a surface substantially parallel to a part of an outer shape of the image forming apparatus main body.

12. The image forming unit according to claim 1, further comprising an intermediate transfer member cleaner that cleans residual toner on the intermediate transfer member.

13. The image forming unit according to claim 12, wherein the intermediate transfer member cleaner is provided at an end of the intermediate transfer member opposite to the image carrier side.

14. An image forming apparatus comprising:
an image forming apparatus main body; and
an image forming unit detachably attachable to the image forming apparatus main body, the image forming unit comprising:
an image carrier that carries a toner image;
an intermediate transfer member being in contact with the image carrier in an area, onto which the toner image on the image carrier is transferred; and
an image carrier cleaner that cleans residual toner on the image carrier, being disposed in contact with the image carrier at a point different from the area where the intermediate transfer member is in contact therewith.

15. The image forming apparatus according to claim 14, wherein the image carrier is provided near an end of the intermediate transfer member.

16. The image forming apparatus according to claim 14, wherein the lengthwise direction of the intermediate transfer member and the point where the image carrier cleaner is in contact with the image carrier make an angle of more than 90° and less than 180° with respect to the center of the area where the intermediate transfer member is in contact with the image carrier.

17. The image forming apparatus according to claim 14, the intermediate transfer member and the image carrier cleaner are disposed along a developing device provided within the image forming apparatus main body.

18. The image forming apparatus according to claim 14, wherein the intermediate transfer member has a surface substantially parallel to a part of an outer shape of the image forming apparatus main body.

19. An image forming apparatus comprising:
an image forming apparatus main body;
a developing device provided within the image forming apparatus main body; and
an image forming unit detachably attachable to the image forming apparatus main body, the image forming unit comprising:
an image carrier that carries a toner image formed by the developing device;
an intermediate transfer member being in contact with the image carrier in an area, onto which the toner image on the image carrier is transferred; and
an image carrier cleaner that cleans residual toner on the image carrier, being disposed in contact with the image carrier at a point different from the area where the intermediate transfer member is in contact therewith.
